(19) United States
(12) Patent Application Publication
(10) Pub. No.: US 2006/0234047 A1
(43) Pub. Date: Oct. 19, 2006

(54) Adhesive packaging tape with natural-rubber hot-melt pressure sensistive adhesive

(75) Inventors: Dieter Wenninger, Hamburg (DE); Werner Karmann, Hamburg (DE); Gerhard Bir, Hamburg (DE); Sven Hansen, Hamburg (DE); Heiko Leydecker, Neustadt/Holstein (DE); Stefanie Kaprolat, Biedenkopf (DE); Ralf Hirsch, Quickborn (DE); Klaus Massow, Hamburg (DE)

Correspondence Address: Norris, McLaughlin & Marcus P.A., 18th Floor, 875 Third Avenue, New York, NY, 10022, US

(73) Assignee: tesa Aktiengesellschaft, Hamburg (DE)

(21) Appl. No.: 11/454,045

(22) Filed: Jun. 15, 2006

Related U.S. Application Data
(62) Division of application No. 09/641,014, filed on Aug. 17, 2000.

(30) Foreign Application Priority Data
Aug. 18, 1999 (DE) 199 39 076.2

(51) Int. Cl. B32B 7/12

(52) U.S. Cl. 428/355 R

(57) ABSTRACT

Adhesive tape comprising a backing comprising an oriented thermoplastic film and a coating comprising a solventlessly prepared pressure-sensitive adhesive composition based on non-thermoplastic elastomers such as natural rubber and tackifying resins, characterized in that the pressure-sensitive adhesive composition comprises a thermally labile crosslinking system.

The invention relates to adhesive tapes comprising adhesive compositions based on natural-rubber hot-melt pressure-sensitive adhesives applied and prepared without solvent, and comprising backings based on thermoplastic films.

Adhesive tapes with films based on thermoplastics, such as, for example, oriented polyolefins, PET or PVC, and adhesive compositions based on solvent-containing natural-rubber compositions, are known and are supplied by known manufacturers.

Owing to the known disadvantages associated with the production of solvent-containing adhesive tapes, such as, for example, complex recycling of solvents, emission of solvents to the environment, workplace hazards due to highly flammable solvents, and the restriction on coating speed imposed by the drying of the adhesive composition, solvent-free technologies for producing adhesive tapes are increasing in importance.

The solvent-free technology for producing adhesive tapes, especially adhesive packaging tapes, has to date been limited to the use of melting thermoplastic elastomers. An advantage of these thermoplastic elastomers, predominantly block copolymers comprising polystyrene blocks, is the relatively low softening point and the corresponding simplification of the application or coating process, and also the avoidance of the above-described disadvantages of the solvent-based technology.

The unfavourable ageing behaviour and the profile of properties of such packaging tapes at increased temperatures, the poor thermal stability, result in premature opening of the boxes packed up using these packaging tapes, and/or a performance profile which is, in general, to some extent unfavourable for adhesive packaging tapes.

Various routes to the solvent-free preparation and processing of pressure-sensitive rubber adhesives are known.

All of the known processes are distinguished by very extensive rubber breakdown. For the further processing of the compositions to self-adhesive tapes, this requires extreme crosslinking conditions and also has the consequence of an application profile which is restricted to some extent, especially as regards the use of resultant self-adhesive tapes at relatively high temperatures.

The patent CA 698 518 describes a process for achieving production of a composition by adding high proportions of plasticizer and/or by simultaneously strong mastication of the rubber. Although this process can be used to obtain pressure-sensitive adhesives having an extremely high tack, user-compatible shear strength, even with a relatively high level of subsequent crosslinking, can be achieved only to a limited extent owing to the relatively high plasticizer content or else to the severe breakdown in molecular structure of the elastomer to a molecular weight average of M_{w}≦1 million.

The use of polymer blends, where besides non-thermoplastic natural rubber use is also made of block copolymers, in a ratio of approximately 1:1, is essentially an unsatisfactory compromise solution, since it results neither in high shear strengths when the self-adhesive tapes are used at relatively high temperatures nor in significant improvements relative to the properties described in the patent.

The deliberate industrial process of rubber breakdown under the combined action of shear stress, temperature and atmospheric oxygen is referred to in the technical literature as mastication and is generally carried out in the presence of chemical auxiliaries, which are known from the technical literature as masticating agents or peptizers, or, more rarely, as “chemical plasticizing aids”.

In rubber technology, the mastication step is necessary in order to make it easier to integrate the additives.

According to Römpp (Römpp Lexikon Chemie—version 1.5, Stuttgart/New York: Georg Thieme Verlag 1998), mastication is a term used in rubber technology for the breakdown of long-chain rubber molecules in order to increase the plasticity and/or reduce the (Mooney) viscosity of rubbers. Mastication is accomplished by treating, in particular, natural rubber in compounders or between rolls at very low temperatures in the presence of mastication agents. The high mechanical forces which this entails lead to the rubber molecules being “torn apart”, with the formation of macroradicals, whose recombination is prevented by reaction with atmospheric oxygen. Mastication agents such as aromatic or heterocyclic mercaptans and/or their zinc salts or disulphides promote the formation of primary radicals and so accelerate the mastication process. Activators such as metal (iron, copper, cobalt) salts of tetraazaporphyrins or phthalocyanines permit a reduction in the mastication temperature. Mastication agents are used in the mastication of natural rubber in amounts of from about 0.1 to 0.5% by weight in the form of masterbatches which facilitate uniform distribution of this small amount of chemicals in the rubber composition.

Mastication must be clearly distinguished from the breakdown known as degradation which results in all of the standard solvent-free polymer technologies such as compounding, conveying and coating in the melt.

Degradation is a collective designation for various processes which alter the appearance and properties of plastics. Degradation may be caused, for example, by chemical, thermal, oxidative, mechanical or biological influences or else by exposure to radiation (such as (UV) light. Consequences are, for example, oxidation, chain cleavage, depolymerization, crosslinking, and/or elimination of side groups of the polymers. The stability of polymers to degradation may be increased by means of additives, for example by adding stabilizers such as antioxidants or light stabilizers.

Uncontrolled degradation often constitutes an unwanted phenomenon. It can be minimized by providing an inert gas atmosphere.

The use of non-thermoplastic elastomers is also described in JP 95 331 197, where use is made of an isocyanate-reactive natural rubber (polyisoprene grafted with maleic ester) having an average molecular weight M_{w}<1 million with aliphatic non-reactive hydrocarbon resins, which is crosslinked with blocked isocyanates (for example Desmodur CT); the mixture is initially crosslinked at 150° C. for five minutes and following its subsequent coating onto PET film is cured at 180° C. for several minutes (for example 15 minutes). This procedure clearly shows how complicated it is to achieve postcrosslinking if the natural rubber is subjected to excessive breakdown during the production process.

The patent application JP 95 278 509 discloses a self-adhesive tape in which the natural rubber is masticated to an average molecular weight of M_{w}=100,000 to 500,000 in order to obtain a coatable homogeneous mixture comprising hydrocarbon resins, rosin/rosin derivative resins and terpene resins, which can be processed readily at between 140° C. and 200° C. with a coating viscosity from 10 to 50×10³ cps but requires an extremely high EBC dose (400 kGy) in order to ensure the shear strength necessary for its use.

For backing materials based on polyolefins, therefore, the system is unsuitable, since at the necessarily high beam doses there is significant backing deterioration. In the field of adhesive packaging tapes, such backing deterioration is unacceptable.

The term “adhesive packaging” or “adhesive tapes suitable for packaging” embraces on the one hand the adhesive packaging tapes for sealing cardboard packaging and on the other hand the strapping tapes used for firm bundling and palletization of cardboard packaging and other goods.

The use of exclusively non-thermoplastic rubbers as the elastomer component in the formulation of pressure-sensitive adhesives (PSAs) with the existing cost advantage possessed, for example, by natural rubbers over the standard commercial block copolymers, and with the outstanding properties, especially the shear strength of the natural rubber and corresponding synthetic rubbers, is also set out at length in the patents WO 94 11 175, WO 95 25 774, WO 97 07 963 and, correspondingly, U.S. Pat. No. 5,539,033 and U.S. Pat. No. 5,550,175.

In these cases, the additives customary in PSA technology, such as tackifier resins, plasticizers and fillers, are described.

The production process disclosed in each case is based on a twin-screw extruder which permits compounding to a homogenized PSA blend with the chosen process regime, involving mastication of the rubber and subsequent gradual addition of the individual additives with an appropriate temperature regime.

The mastication step of the rubber, which precedes the actual production process, is described at length. It is necessary and characteristic of the process chosen, since with the technology selected therein it is indispensable to the subsequent integration of the other components and to the extrudability of the blended composition. Also described is the feeding-in of atmospheric oxygen, as recommended by R. Brzoskowski, J. L. and B. Kalvani in Kunststoffe 80 (8), (1990), p. 922 ff., in order to accelerate rubber mastication.

This procedure makes it absolutely necessary to practice the subsequent step of electron beam crosslinking (EBC) and to use reactive substances as EBC promoters in order to achieve an effective crosslinking yield.

Both process steps are described in the abovementioned patents, but the EBC promoters selected also tend towards unwanted chemical crosslinking reactions at elevated temperatures. This limits the use of certain tackifying resins.

Owing to the unavoidable high production temperatures, compounding in a twin-screw extruder prevents the use of heat-activatable substances suitable for crosslinking the adhesive compositions, such as, for example, crosslinkers based on diisocyanate or other crosslinkers, since the chemical crosslinking reactions and secondary reactions that ensue in the process result in such a great increase in viscosity that the coatability of the resulting PSA composition is impaired and the composition therefore cannot be coated by means of nozzle coating.

The solvent-free hot-melt PSAs developed in recent years, based on non-thermoplastic elastomers, such as natural rubber or other high molecular mass rubbers, for example, therefore lack sufficient cohesion for the majority of applications, in the absence of a step of crosslinking the adhesive composition, and are therefore unsuited to use in the context of an adhesive packaging tape. The cause of this failure of non-crosslinked adhesive compositions based on natural rubber is the relatively large reduction in molecular weight as a result of processing, and/or as a result of the production process of the adhesive compositions based on natural rubber, and the resultant reduced or inadequate cohesion of the adhesive compositions.

The use of adhesive compositions of this kind based on natural-rubber hot-melt PSAs for adhesive tapes, especially adhesive packaging tapes, for sealing recycled-paper cardboard boxes or cardboard packaging, results in premature opening of the boxes. If there is sufficiently great tension across the lid of the box, caused by the pressure of the packaged material in the box or by the tension of the packaging material, which counters sealing, the adhesive tape becomes detached from the surface of the box and the box opens as a result of slippage of the adhesive packaging tape.

Not only for adhesive packaging tapes for sealing cardboard boxes, therefore, but also for other adhesive packaging tapes, such as strapping tapes, there is a need for sufficient cohesion of the adhesive composition based on natural rubber.

The cohesion and, with it, the packaging security afforded by adhesive tapes with an adhesive composition based on natural rubber can be improved either by crosslinking the rubber adhesive composition and/or by means of a preparation variant of the adhesive composition, in which the natural rubber used is broken down to a much-reduced extent and therefore has a higher molecular weight. This makes it possible to counter slippage of the adhesive tapes on the box surface, as described above.

Crosslinking possibilities for adhesive compositions based on natural rubber are known and are used to produce adhesive tapes. The crosslinking of the adhesive composition based on natural rubber may take place directly or by way of the use of a solvent-based primer which comprises a fraction of the suitable crosslinker.

Through migration of the crosslinking primer into the adhesive composition based on natural rubber, the adhesive composition can be durably crosslinked. Disadvantages of this known technology include the use of solvent-containing systems in the course of the coating process, the limiting pot lives of reactive primers of this kind, and the markedly increased expenditure in terms of occupational safety.

The crosslinking of the adhesive compositions based on natural rubber using primers proceeds relatively quickly, assisted by the dissolution effect of solvent-containing adhesive compositions.

The induced chemical crosslinking of an adhesive composition based on natural rubber by isocyanates, such as diisocyanates or polyisocyanates, for example, is known and is used by various adhesive tape manufacturers in combination with solvent-containing adhesive compositions based on natural rubber. Adhesive compositions having improved cohesion, increased heat stability, and optimized packaging security are obtained by this means.

Owing to the unavoidably high process temperatures entailed in the use of known preparation processes for adhesive compositions based on natural rubber hot-melt PSAs, the use of chemical crosslinkers, such as isocyanate systems, for example, has to date been impossible owing to the crosslinking reactions which ensue.

A further possibility is the radiation crosslinking of the adhesive composition. Suitable for this purpose in principle are all types of ionizing radiation which can be used to produce, on the polymer molecules, free radicals or highly excited sites which subsequently react to give crosslinking sites. Particularly suitable are accelerated electrons having energies of from about 50 keV to 300 keV and ultraviolet (UV) rays having wavelengths of from about 200 to 400 nm, since they can be produced at high intensity and the penetration depth can be adapted to the coating thicknesses customary for adhesive tapes.

The fundamental possibilities of accelerated electrons for crosslinking PSA compositions are set out in U.S. Pat. No. 2,956,904. One problem lies in the adverse effect on some substrates. In the case of OPP films, for instance, the light stability is greatly reduced, and PVC films undergo discoloration, especially after storage at elevated temperatures. Both can be reduced by means of specific stabilization, but this entails considerable additional cost.

UV radiation causes no substantial deterioration of the backing films. Crosslinking of the rubber adhesive composition requires the addition of at least one photoinitiator and one crosslinking promoter, as described in U.S. Pat. No. 4,152,231. However, it is necessary to take account here of the absorption by fillers, colour pigments and other additives which leads to a decreasing degree of crosslinking in the depth of the coating. Weak layers of this kind may subsequently result in failure of the adhesive bond, especially on exposure to relatively high temperatures.

Monoaxially and biaxially oriented films based on polypropylene are used in large amounts for adhesive packaging tapes. Whereas biaxially oriented films based on polypropylene are preferred for the use of an adhesive packaging tape for carton sealing, monoaxially oriented polypropylene films find application in the strapping tapes segment. These films are notable for very high tensile strength and low extension in the longitudinal direction and are highly suited to bundling and to the holding-together of pallets. When using adhesive compositions which exhibit inadequate cohesion or inadequate anchoring to the film, the slippage of the strapping tapes results in slipping of the pallets and thus in inadequate securement of the pallets. Insufficient anchoring of the adhesive composition to film leads, when using carton sealing tapes, to premature opening of the packed-up boxes.

A natural rubber hot-melt pressure-sensitive adhesive prepared without solvent, and thus in an environmentally gentle way, in combination with a backing film made from environmentally gentle polypropylene, suggests on conceptual grounds the desire for further environmentally compatible product and production technologies—in so far as they become additionally necessary. Polypropylene, as a nonpolar, saturated hydrocarbon, is not immediately suitable for providing sufficiently firm anchoring of a primer or a natural rubber adhesive composition. This can be remedied to a certain extent by activating oxidative pretreatment of the backing—for example, by corona treatment or flame treatment. Both methods are environmentally gentle, by saving on raw materials, and are attracting very great interest as cost-reducing alternatives to wet-chemical primer coating. The use of a primer alone generally does not solve the anchoring problem on polypropylene; the primer itself requires activation of the backing for its fixing on this substrate. The great efficiency of flame treatment, especially at high web speeds, has been known for a long time, although it is only since modern, readily controllable flaming units have become available that flaming has emerged, in its industrial importance, from the shadow of corona treatment. If the anchoring strength requirements are not too great, flame treatment does in certain cases make it possible to omit the use of a primer. The realization of anchoring, in a manner which meets the requirements, by means of backing flame treatment alone, in the specific case of a natural-rubber hot-melt pressure-sensitive adhesive on polypropylene films for high-quality adhesive packaging tapes, is in ideal harmony with the environmental protection aspects outlined.

Thermoplastic films based on polyethylene terephthalate (PET) or polyvinyl chloride (PVC) are likewise known and are used by various manufacturers to produce adhesive tapes. In this context, films based on PET, in particular, are distinguished by high elongation at break and thermal stability of from 130° C. to 175° C., and resistance to dilute alkalis and acids. Moreover, films based on polyesters possess very high abrasion resistance and penetration resistance, but are less widespread in the field of adhesive packaging tapes owing to the relatively high price in relation to polyolefin-based films.

The PVC may be obtained by emulsion, suspension or bulk polymerization. Copolymers based on PVC/vinyl acetate are also known.

Films based on PVC in combination with solvent-containing adhesive compositions based on natural rubber are offered as adhesive packaging tapes by various manufacturers. In this case, owing to the better thermal stability, unplasticized PVC films are used which have a good thermal stability of up to max. 105° C.

In the production of adhesive tapes with adhesive compositions based on natural rubber, both water-based and solvent-containing primers are used as adhesion promoters between adhesive composition and backing film. These adhesion promoters that are used possess in part a crosslinking effect on the natural-rubber-based adhesive composition which is applied from solution.

Furthermore, the films based on unplasticized PVC are distinguished by moderate penetration strength and a partial resistance to petrol, oil and alcohols. In general, the anchoring of primers to PVC films without corona treatment is better than with other thermoplastic films, such as polyolefin-based films, for example. The reason for this is the high surface energy even without pretreatment [approximately 39 dyn/cm] and the rough surface structure of PVC films. For sufficient anchoring of adhesive compositions based on natural rubber, a primer-coated PVC film is advisable.

It is an object of the present invention to provide adhesive tapes comprising films based on oriented thermoplastic films and solventlessly prepared adhesive compositions based on natural rubber. Furthermore, the new adhesive tapes should unroll readily and have a good bond between adhesive composition and backing film. Furthermore, the new adhesive tapes should be suitable either as adhesive packaging tapes or as strapping tapes for standard commercial cardboard packaging.

This object is achieved by means of an adhesive tape as set out in the main claim. The subsidiary claims relate to advantageous developments of the subject-matter of the invention. Furthermore, the invention provides processes for producing and proposals for using the adhesive tape of the invention.

The invention accordingly provides an adhesive tape comprising a backing comprising an oriented thermoplastic film and a coating comprising a solventlessly prepared pressure-sensitive adhesive composition based on non-thermoplastic elastomers such as natural rubber and tackifying resins, the pressure-sensitive adhesive composition comprising a thermally labile crosslinking system.

Films based on polyesters, for example polyethylene terephthalate, are likewise known and may also be used to produce the adhesive tapes of the invention. The thicknesses of the films based on PET are between 20 and 100 μm, in particular between 30 and 50 μm.

Films based on oriented polyolefins are known and belong to the prior art. Monoaxially and biaxially oriented films based on polyolefins are used in large amounts for adhesive packaging tapes, strapping tapes, and other adhesive tapes. Films based on oriented polyethylene or oriented copolymers comprising ethylene and/or polypropylene units are also known. All of these films may be used as backing film in accordance with the invention.

Monoaxially oriented polypropylene is noted for its very high tensile strength and low elongation in the longitudinal direction and is used, for example, to produce strapping tapes. Monoaxially oriented films based on polypropylene are preferred for producing the adhesive tapes of the invention for bundling and palletizing cardboard packaging and other goods. The thicknesses of the monoaxially oriented films based on polypropylene are preferably between 25 and 200 μm, in particular between 40 and 130 μm.

Films comprising monoaxially oriented polypropylene are particularly suitable for producing the adhesive tapes of the invention. Monoaxially oriented films are predominantly single-layered, although multilayer monoaxially oriented films may also be produced in principle. The known films are predominantly one-, two- and three-layer films, although the number of layers chosen may also be greater.

For the production of the adhesive tapes of the invention for secure carton sealing, preference is given to biaxially oriented films based on polypropylene with a draw ratio in the longitudinal (machine) direction of between 1:4 and 1:9, preferably between 1:4.8 and 1:6, and a draw ratio in the transverse (cross) direction of between 1:4 and 1:9, preferably between 1:4.8 and 1:8.5.

The moduli of elasticity achieved in the longitudinal direction, measured at 10% elongation in accordance with ASTM D882, are usually between 1000 and 4000 N/mm², preferably between 1500 and 3000 N/mm².

The thicknesses of the biaxially oriented films based on polypropylene are in particular between 15 and 100 μm, preferably between 20 and 50 μm.

Biaxially oriented films based on polypropylene may be produced by means of blown film extrusion or by means of customary flat film units. Biaxially oriented films are produced both with one layer and with a plurality of layers. In the case of the multilayer films, the thickness and composition of the different layers may also be the same, although different thicknesses and compositions are known.

Particularly preferred for the adhesive tapes of the invention are single-layer, biaxially or monoaxially oriented films and multilayer biaxial or monoaxial films based on polypropylene which have a sufficiently firm bond between the layers, since delamination of the layers in the course of the application is disadvantageous.

Films based on unplasticized PVC are likewise known and are used by various adhesive tape manufacturers to produce adhesive packaging tapes. Plasticized PVC, owing to the inadequate thermal stability of max. 60° C., is unsuited to the production of adhesive packaging tapes but may, if desired, also be used.

For the adhesive tapes of the invention for secure carton sealing it is preferred to use films based on unplasticized PVC. The thicknesses of the films are preferably between 30 and 100 μm, in particular between 35 and 50 μm. The adhesive tapes of the invention are used as packaging tapes for carton sealing.

In one preferred embodiment of the adhesive tape, the adhesion of the adhesive composition on the thermoplastic film based on polyolefins is improved by means of corona treatment or, especially, by means of flame pretreatment, since, especially, the surfaces of films based on oriented polyolefins may be treated by means of these widely known processes, such as corona treatment or flame treatment. Preference is given to surface treatments by flame pretreatment. An overview of the processes for surface treatment is contained, for example, in the article “Surface pretreatment of plastics for adhesive bonding”/A. Kruse; G. Krüger, A. Baalmann and O. D. Hennemann; J. Adhesion Sci. Technol., Vol. 9, No. 12, pp. 1611-1621 (1995).

The biaxially or monoaxially oriented films based on polyolefins for the adhesive tapes of the invention are preferably corona- and/or flame-pretreated on the side facing the adhesive composition in order to obtain sufficient anchoring of the adhesive composition on the film. Flame pretreatment is the preferred form of film pretreatment for films based on oriented polyolefins.

The flaming installation comprises at its core a coolable burner unit and a likewise coolable treatment roll, which serves to guide the web. While the burner temperature in the course of flaming is held at between 30° C. and 40° C., the cooling of the treatment roll ensures temperatures there of between 10° C. and 15° C. The film web is guided and treated between burner and treatment roll under defined conditions. The flaming of the abovementioned polyolefin films takes place by way of a fuel gas/air mixture in optimized composition. The fuel gas fraction comprises gaseous hydrocarbons such as propane or butane or hydrocarbon mixtures in the form, for example, of standard commercial natural gas. Depending on the precise composition of the fuel gas/air mixture, flame temperatures of between 750° C. and 900° C. are achieved. The distance of the burner unit from the treatment roll may be regulated between 2 mm and 7.5 mm. Web speeds can be set within the limits from 30 m/min up to several hundred m/min.

An upper limit results from the capacity of the available installation, i.e. the total installation including coating section in the case of in-line backing treatment, or the flaming installation in the case of off-line backing pretreatment.

The lower limit is governed by the thermal sensitivity of the film material. The energy input can be varied by way of the volume flow of the mixture, at given settings for mixture composition, burner distance and web speed, within limits from 20 m³/h to 50 m³/h. In addition, the effective flaming width can be adjusted to different film widths by way of adjustable burner boundary.

Backing material flamed under optimized parameters is coated with natural-rubber hot-melt pressure-sensitive adhesive no later than one day following pretreatment. A similar procedure is followed for comparative material which has been appropriately corona-pretreated. With suitable plant construction, in-line flaming or corona pretreatment prior to coating of the adhesive composition based on natural-rubber hot-melt pressure-sensitive adhesives is possible and leads to a further improvement in the anchoring of the composition.

The anchoring strength of the adhesive composition is tested on finished adhesive tapes, especially after a matured state has been reached. In the course of this testing, the question as to on-specification anchoring strength is of just as much interest as the comparison between flaming and corona pretreatment.

It is found that flaming of the backing brings about far better anchoring of natural-rubber hot-melt pressure-sensitive adhesives than a corona pretreatment appropriate for comparison. Anchoring on the pretreated backing undergoes further, considerable increase if the natural-rubber hot-melt pressure-sensitive adhesive comprises isocyanate crosslinkers. Especially in combination with the flaming of the backing, it is in some cases possible by this means to forego the use of a primer, which in turn permits the omission of a drying tunnel in the coating process, this process thus being totally solvent-free.

The adhesive composition itself preferably comprises a mixture comprising:
a) 100 parts by weight of natural rubber (granulated)
b) 70-120 parts by weight of tackifying resins based on hydrocarbons
c) 5-30 parts by weight of fillers, for example chalk and/or organic or inorganic pigments
d) 2-20 parts by weight of plasticizers, for example mineral oil
e) 0.1-15 parts by weight of a crosslinker system
f) 0.5-5 parts by weight of ageing inhibitors.

If desired, the mixture may be further supplemented by
g) 0-10 parts by weight of organic and inorganic pigments.

The application rate of the adhesive composition to the backing material, especially a thermoplastic film made from oriented polyolefins, PVC or PET, is preferably from 10 to 50 g/m². In a further preferred embodiment, the layer application established is from 14 to 25 g/m².

The adhesive tapes of the invention may comprise further layers. The use of appropriate primers, disposed between adhesive layer and film, is possible provided it does not reduce the good anchoring, in accordance with the invention, between the adhesive composition based on natural-rubber hot-melt pressure-sensitive adhesive and the flame- or corona-treated film. The use of an appropriate coating, for example a release coating, is possible.

Adhesive compositions based on natural rubber have been known for a long time and are widely used for adhesive packaging tapes. An overview of the adhesive compositions and their use in the field of pressure sensitive adhesives can be found in “Natural Rubber Adhesives” (G. L. Butler in Handbook of Pressure Sensitive Adhesive Technology, Third Edition, edited by Donatas Satas, Van Nostrand Reinhold New York, pp. 261-287).

The high molecular weight and the unsaturated molecule chains of the natural rubber govern its advantages in terms of material properties and at the same time the problems associated with its processing. For performance-capable adhesive tapes, natural rubber can to date be processed only by solvent technology. This technology has limits in economics, environmental acceptance, and the further development of the adhesive compositions for adhesive packaging tapes. Known solvent-free technologies, such as, for example, the use of thermoplastic block copolymers comprising polystyrene blocks, are based on low melt viscosities, which lead to poor thermal stability. These low melt viscosities are not present in the case of natural rubber. Furthermore, high process temperatures in the case of natural rubber result in thermooxidative damage, owing to the unsaturated natural rubber molecules. The combination of planetary roll extruders as a suitable compounder unit and the coating of the adhesive composition by means of a roll applicator permits the use of solventlessly prepared adhesive compositions based on natural rubber for adhesive packaging tapes and combines the efficiency of the hot-melt pressure-sensitive adhesive technology with the advantages of the natural rubber technology.

The adhesive compositions of the invention based on natural rubber are prepared and applied without solvent and comprise in particular crepe, SSR or ADS, TSR grades of natural rubber as the natural rubber component. Particular preference is given to ADS and TSR rubber grades as the natural rubber component.

In order to be able to incorporate different components into the natural rubber fraction of the adhesive composition, to date the drastic breakdown of the molecular weight of the rubber has been absolutely necessary for producing the adhesive composition. This process (mastication) takes place by way of special compounders and is particularly shear-intensive. The extent of the breakdown in molecular weight can be controlled within certain limits via the input of shear energy, temperature, and controlled action of oxygen. The use of a planetary roll extruder for producing the adhesive compositions based on natural rubber makes it possible to produce homogenized adhesive compositions by means of very high shear rates in conjunction with excellent heat exchange and a very short residence time of the composition. This brings about a relatively low reduction in the molecular weight of the natural rubber at simultaneously low process temperatures of from 90 to 110° C.

Tackifying resins based on hydrocarbons are known and are in very widespread use for adhesive compositions for adhesive packaging tapes. A description and possible uses in connection with natural-rubber-based adhesive compositions is described, for example, in “Natural Rubber Adhesives” (G. L. Butler in Handbook of Pressure Sensitive Adhesive Technology, Third Edition, edited by Donatas Satas, Van Nostrand Reinhold New York, pp. 263-266). Hydrocarbon-based tackifying resins are available commercially with a range of different properties such as, for example, different chemical structure, colour grades and softening points.

For the solvent-free, natural-rubber-based adhesive compositions of the invention, hydrocarbon-based tackifying resins are used. The solvent-free adhesive composition based on natural rubber comprises from 70 to 120 parts of tackifying resin and preferably from 80 to 110 parts of tackifying resin per 100 parts of natural rubber.

The use of tackifying resins based on mixtures of different hydrocarbon resins and on mixtures of hydrocarbon resins of the invention with other known resins is also in accordance with the invention provided that it does not alter the characteristic profile of properties of the adhesive tapes of the invention in a manner detrimental to those properties. Possible, for example, are mixtures of hydrocarbon resins with fairly small amounts of tackifying resins based on rosin or modified rosin or on phenolic resins, other natural resins, resin esters or resin acids.

The use of plasticizers as additives to adhesive compositions for adhesive packaging tapes is known.

For the adhesive tapes of the invention, use is made of from 2 to 20 parts of plasticizer, based on paraffinic and naphthenic oils, oligomers such as oligobutadienes and oligoisoprenes, liquid nitrile rubbers, liquid terpene resins, vegetable and animal oils and fats and phthalates, per 100 parts of natural rubber.

Particularly preferred for the adhesives of the invention are solvent-free adhesive compositions based on natural rubber and comprising from 4 to 10 parts of plasticizer. Particular preference is given to the use of paraffinic and naphthenic oils.

Ageing inhibitors for adhesive compositions based on natural rubber are known. Three different kinds of ageing inhibitor are used in particular as antioxidants for adhesive compositions: ageing inhibitors based on amines, on dithiocarbamates, and on phenols. Ageing inhibitors based on phenols are very effective under the influence of UV radiation and sunlight.

For the adhesive tapes of the invention, ageing inhibitors based on phenols are used. The adhesive composition comprises in particular, from 0.5 to 5 parts of an appropriate ageing inhibitor, based on phenols, per 100 parts of natural rubber. Also in accordance with the invention is the use of other types of ageing inhibitor, such as, for example, ageing inhibitors based on amines and dithiocarbamates.

Organic and inorganic pigments for adhesive compositions based on natural rubber are known. For the colouring of adhesive compositions based on natural rubber, use is made in particular of titanium dioxide or titanium dioxide in combination with different-coloured colour pigments.

For the adhesive tapes of the invention, suitable organic and/or inorganic colour pigments are used. The adhesive composition comprises from 0 to 10 parts of an organic and/or inorganic colour pigment, per 100 parts of natural rubber. Particular preference is given to the use of from 0 to 7 parts of an appropriate organic or inorganic colour pigment per 100 parts of natural rubber. Also in accordance with the invention is the use of pigments based on mixtures of different inorganic and organic pigments.

Suitable fillers for adhesive compositions based on natural rubber are known. In this instance, calcium carbonate (chalk), titanium dioxide, zinc oxide, clay or pigments are used in particular. For the adhesive tapes of the invention, fillers based on chalk, titanium dioxide, clay or pigments are used. The adhesive composition comprises from 10 to 30 parts of fillers, in particular from 10 to 20 parts of fillers, per 100 parts of natural rubber. Particular preference is given to the use of calcium carbonate (chalk) as filler. Also in accordance with the invention is the use of fillers based on mixtures of different fillers.

The crosslinking of adhesive compositions based on natural rubber is known and is described, for example, in “Natural Rubber Adhesives” G. L. Butler in Handbook of Pressure Sensitive Adhesive Technology, Third Edition, edited by Donatas Satas, Van Nostrand Reinhold New York, pp. 269-276. The adhesive composition based on the natural rubber is crosslinked either by using chemical crosslinkers or by using physical crosslinking methods such as electron beam crosslinking or crosslinking by means of UV radiation.

For the purpose of chemically-thermally induced crosslinking it is possible in general to use known crosslinkers such as accelerated sulphur systems or sulphur donor systems, isocyanate systems, reactive melamine resins, formaldehyde resins and (optionally halogenated) phenol-formaldehyde resins and/or reactive phenolic resin crosslinking systems or diisocyanate crosslinking systems with the appropriate activators, epoxidized polyester resins and acrylate resins, and combinations thereof.

Crosslinkers based on isocyanates, such as diisocyanate systems or polyisocyanates, for example, are particularly preferred. The use of these crosslinking systems is known in principle and is described, for example, in GB 1,234,860.

The adhesive compositions of the adhesive tapes of the invention comprise from 0.1 to 15 parts of a suitable crosslinker per 100 parts of natural rubber.

In one preferred embodiment the adhesive composition comprises from 0.1 to 5 parts of an isocyanate, such as diisocyanates or polyisocyanates, in a particularly preferred embodiment from 0.5 to 2.0 parts of isocyanates, per 100 parts of natural rubber. The amount of suitable crosslinker may be adapted to the amount of tackifying resin according to the invention.

Radiation crosslinking has the advantage of very rapidly achieving a high degree of crosslinking which then remains stable over a long period. Consequently, in-line crosslinking is possible even at high coating speeds of several 100 m/min, and in contrast to chemical crosslinking the quality of the adhesive properties can be checked directly after the end of production.

By controlling the intensity of radiation it is possible to establish the desired degree of crosslinking within wide ranges, independently of the web speed.

Rubber adhesive compositions may be crosslinked by means of accelerated electrons without specific additives. In order to raise the crosslinking yield it is possible to add crosslinking promoters such as polyfunctional (meth)acrylates, thiols or bismalimides. The available installations and the most important process parameters have been disclosed elsewhere (W. Karmann, J. of Industrial Irradiation Technology 1(4) (1983) pp. 305-323).

Owing to the damage caused to numerous important packaging tape backings such as OPP and PVC films by EBC, the crosslinking of the adhesive composition by UV radiation is particularly advantageous. For this purpose it is necessary to add photoinitiators and crosslinking promoters to the rubber adhesive composition. Examples of photoinitiators which may be used include aromatic ketones, benzoin and derivatives, benzil and dialkyl ketals derived therefrom, thioxanthans, anthraquinones, anthracenes and phosphine oxides. Suitable crosslinking promoters include acrylic and methacrylic esters of polyfunctional alcohols such as hexanediol, trimethylolpropane and the ethoxylated and dimerized derivatives thereof, pentaerythritol and the dimer, polyethylene glycol and polypropylene glycol. For hot-melt pressure-sensitive adhesives, compounds with relatively high molecular weights are generally preferred owing to their lower vapour pressure. Acrylic esters usually give higher reaction rates.

In the case of UV crosslinking, it is necessary to bear in mind the absorption of the radiation by the photoinitiator and by organic and inorganic pigments in the adhesive composition, which leads to a sharp decrease in the degree of crosslinking with penetration in the adhesive composition layer. Excessive crosslinking on the surface of the adhesive composition has the consequence of unfavourable adhesive properties.

This can be avoided, or at least reduced, if the adhesive composition is irradiated through the backing film or from both sides. The effect may also be reduced by reducing the shortwave component of the radiation with a wavelength of less than about 300 nm by means of various measures. Suitable radiation tubes for this purpose are available on the market. The component may also be eliminated by means of appropriate filtering.

The radiation intensity can be controlled by incorporating radiation tubes and also, within certain limits, by controlling the output of the radiation emitters, as described by A. Beying, RadTech Europe '97.

Advantageously, moreover, the effect of atmospheric oxygen on the surface of the adhesive composition to be crosslinked is excluded. This can be achieved by blanketing with inert gases such as nitrogen, carbon dioxide and/or noble gases such as argon or by covering with a release liner (release paper or release films) which may, if desired, be transparent.

In one further embodiment, accordingly, the adhesive compositions of the adhesive tapes of the invention comprise not only from 0.1 to 5 parts, preferably from 0.5 to 3 parts, of at least one photoinitiator but also from 0.5 to 10 parts, preferably from 1 to 5 parts, of a polyfunctional (meth)acrylic ester. The amount of appropriate crosslinker may be adapted to the amount of the resin that is used.

For the electron beam crosslinking of adhesive compositions with coatings of from 10 to 50 g/m², it is preferred to use lead-shielded single-stage electron accelerators with voltages of from about 50 to 300 kV, which owing to their relatively small dimensions are easy to integrate into the coating installations. The types available on the market are described by G. G. Skelhorne (“Electron Beam Processing” in Vol. 1 “Chemistry & Technology of UV & EB Formulations for Coatings, Inks & Paints” publ. Sita Technology, London 1991).

UV radiation installations comprise one or more gas discharge tubes, which are mostly provided with elliptical or parabolic reflectors and with an effective cooling means. An overview of the different tubes and the other components is given by R. E. Knight (“UV Curing Equipment and Applications” in Vol. 1 “Chemistry & Technology of UV & EB Formulations for Coatings, Inks & Paints” publ. Sita Technology, London 1991).

The production of the adhesive composition based on natural rubber of the adhesive tapes suitable for packaging may take place by means of a single-layered or multilayerd production. Suitable in this context are, for instance, production in the batch process and the use of twin-screw extruders. Overall it is possible to coat adhesive compositions of this kind onto thermoplastic films by means of the abovementioned roll applicator.

In this case, in the context of batchwise production, a pre-batch is prepared using a Banbury compounder and then mixing is completed with the aid of a kneading machine after the complete raw-material components have been added.

The invention then embraces a process for continuous solvent-free and mastication-free preparation of pressure-sensitive adhesive compositions based on non-thermoplastic elastomers in a continuously operating device having a filling section and a compounding section, comprising the following steps:
a) feeding the solid components of the self-adhesive composition, such as elastomers and resins, into the filling section of the device,
   optionally feeding fillers, dyes and/or crosslinkers,
b) transferring the solid components of the self-adhesive composition from the filling section to the compounding section,
c) adding the liquid components of the self-adhesive composition, such as plasticizers, crosslinkers and/or further tackifying resins, if desired in the melted state, to the compounding section,
d) preparing a homogeneous self-adhesive composition in the compounding section,
e) discharging the self-adhesive composition, and
f) coating the self-adhesive composition onto a material in web form, the coating of the web-form material being carried out with a multi-roll applicator, in particular with a 2- to 5-roll applicator, especially with a 4-roll applicator, so that the self-adhesive composition is shaped to the desired thickness as it passes through one or more roll nips,
   it being possible to set the rolls of the applicator individually to temperatures of from 20° C. to 150° C.

The use of a planetary roll extruder as a continuously operating device has been found to be particularly advantageous, the compounding section of the said device comprising preferably at least two, but with particular preference three, coupled roll cylinders, it being possible for each roll cylinder to have one or more separate temperature control circuits.

Unlike otherwise conventional production processes, in the planetary roll extruder in accordance with the process of the present invention, in particular, there is no property-impairing mastication of the non-thermoplastic elastomers, since in this case they are not subjected separately to the effect of high shear energy but instead are always processed together with one or more liquid components. These liquid components may include plasticizers such as oils, for example, and also resins which melt only during the compounding process under the action of shear energy and/or external heating. The presence of these liquid components limits the extent of frictional energy such that it is possible to avoid the mastication of the rubber, i.e. the molecular weight breakdown of the elastomers, and the high resultant compounding temperatures.

Furthermore, planetary roll extruders have extremely large areas where heat exchange, material exchange and surface renewal take place, by which means it is possible to dissipate rapidly the frictional shear energy and thus to avoid undesirably high product temperatures.

Planetary roll extruders have been known for a fairly long time and were first used in the processing of thermoplastics such as PVC, for example, where they were used primarily to supply the downstream units such as, for example, calenders or roll mills. As a consequence of their advantage of the great renewal of surface area for material exchange and heat exchange, by means of which the frictional energy can be dissipated rapidly and effectively, and because of the low residence time and the narrow residence-time spectrum, their use in recent times has been extended, inter alia, to compounding processes which require a particularly temperature-controlled regime.

Depending on manufacturer, planetary roll extruders are available in various designs and sizes. The diameters of the roll cylinders, depending on the desired throughput, are typically between 70 mm and 400 mm.

Planetary roll extruders generally have a filling section and a compounding section.

The filling section comprises a conveying screw to which all of the solid components are fed continuously. The conveying screw then passes the material to the compounding section. The region of the filling section, together with the screw, is preferably cooled in order to prevent baking-on of material on the screw. Alternatively, there are designs without a screw section, where the material is fed directly between central spindles and planetary spindles. However, this is not significant for the effectiveness of the process of the invention.

The compounding section comprises a driven central spindle and a plurality of planetary spindles which rotate around the central spindle within a roll cylinder with internal helical gearing. The rotary speed of the central spindle, and hence the rotational speed of the planetary spindles, can be varied and is therefore an important parameter for controlling the compounding process.

The materials are circulated between the central and planetary spindles, and between the planetary spindles and the helical gearing of the roll section, so that under the effect of shear energy and external heating the materials are dispersed to form a homogeneous compound.

In this context, reference is made to the patent applications and, respectively, utility model DE 196 31 182, DE 94 21 955, DE 195 34 813, DE 195 18 255, DE 44.33 487, which offer an overview of the state of the art in the field of planetary roll extruders.

It is advantageous to use a planetary roll extruder whose compounding section has been extended by coupling at least two roll cylinders. Firstly, despite the presence of friction-reducing components for the purpose of avoiding mastication of the rubber, the complete digestion of the elastomer components, and the desired homogenizing and dispersing performance at economic throughput rates, is possible by this means; secondly, the coupling of, preferably, separately temperature-controlled roll cylinders permits a balanced temperature regime in the process, so allowing the use of heat-activatable crosslinker systems.

Whereas in the front compounding section of the planetary roll extruder the roll cylinders are advantageously heated at temperatures above the melting point of the resins used, the rear compounding section is advantageously cooled in order to reduce the product temperature. By this means, the residence time of the self-adhesive composition at relatively high temperatures is kept as short as possible, thereby preventing activation of the thermal crosslinker systems present in the self-adhesive composition.

In the first step of the process, a composition comprising the elastomers and the known additives required for the preparation of self-adhesive compositions, such as fillers, ageing inhibitors, plasticizers and tackifying resins, is prepared without solvent in a planetary roll extruder, the composition having a final temperature of less than 150° C., preferably less than 130° C., with very particular preference between 70° C. and 110° C.

The overall residence time of the composition within the planetary roll extruder should not exceed a level of three minutes. The resulting hot-melt adhesive composition has a viscosity of between 300 and 1500 Pa*s in particular a viscosity of between 800 and 1200 Pa*s at 130° C. and a shear rate of 100 rad/s.

In the second step of the process, which advantageously takes place in conjunction with the compounding step in the planetary roll extruder, the pressure-sensitive hot-melt adhesive composition prepared in accordance with the invention is coated without solvent onto a backing in web form, using an applicator unit.

In accordance with the invention it is further proposed to carry out the coating of the web-form material without solvent using a roll coating applicator unit or muliti-roll coating calenders comprising preferably three, with particular preference four, coating rolls, the self-adhesive composition being shaped to the desired thickness as it passes through one or more roll nips before transfer to the web-form material. This coating process is particularly preferable when the viscosities of the self-adhesive composition exceed levels of 5000 Pa*s at a shear rate of 1 rad/s, since in this case coating with extrusion dies no longer provides the necessary accuracy in terms of the amount of composition applied. Depending on the nature of the web-form backing material to be coated, coating may take place in a co-rotating or counter-rotating process.

Coating on roll coating applicator units or multiroll coating calenders is possible at temperatures below 100° C., so that even self-adhesive compositions containing heat-activatable crosslinkers can be coated. The roll which carries the backing is cooled at from 5° C. to 25° C., preferably from 10 to 15° C. It is possible as a result to coat heat-sensitive backings, such as unplasticized PVC for example.

The rolls of the applicator unit may be set individually at temperatures from 20° C. to 150° C.

The preferred 4-roll applicator unit is formed of a metering roll, a knife-coating roll, which determines the thickness of the layer on the backing material and is arranged parallel to the metering roll, and a transfer roll, which is situated below the metering roll. On the placement roll, which together with the transfer roll forms a second roll nip, the composition and the web-form material are brought together. The placement roll is cooled at a temperature of from 5 to 25° C., preferably from 10 to 15° C.

It is thus possible, without wishing hereby to restrict the concept of the invention, for the differential speeds in the case of an appropriate 4-roll applicator unit to be as follows:

| | Differential speed with respect to the |
|---|---|
| | relative web speed |
| Roll | [%] |
| Metering roll | from 0.1 to 25 |
| | in particular from 1 to 2 |
| Knife-coating roll | from 10 to 100 |
| | in particular from 30 to 40 |
| Transfer roll | from 10 to 100 |
| | in particular from 75 to 90 |

For the purpose of increased freedom of the coated adhesive composition from gas bubbles, it is possible to install a vacuum devolatilizer between planetary roll extruder and applicator unit, for example a vacuum chamber, a devolatilizing extruder or the like.

The adhesive tapes of the invention are suitable for a large number of adhesive tape applications. One important field of application is that of packaging applications. The adhesive tapes are suitable for use as carton sealing tapes, general adhesive packaging tapes, strapping tapes, and adhesive tapes for sealing plastic packaging and plastic bags. The adhesive tapes are suitable for pallet securement. Further applications are the bundling of loose goods and goods for transportation, such as pipes, wooden strips, etc., for example. The adhesive tapes of the invention may be used to secure, for example, refrigerators and other electrical and electronic appliances when in transit. Further applications are label protection, surface protection, in the construction sector, for example, and tear-open strips for packaging. Applications within the office sector are also possible.

The intention of the text below is to illustrate the invention, with reference to examples, without wishing unnecessarily to restrict the invention.

### EXAMPLES

### Example a

### Film

A biaxially oriented film based on polypropylene is used, from Radici.

| | |
|---|---|
| Film thickness | 25 μm |
| Designation | Radil T 25 NT (NT = Not treated) |
| Company/manufacturer | Radici |
| Elongation at break, | 130% |
| longitudinal | |
| Elongation at break, | 50% |
| transverse | |
| Modulus of elasticity | 2500 N/mm² |
| longitudinal | |
| Modulus of elasticity | 4000 N/mm² |
| transverse | |
| Thermal shrinkage at | longitudinal <5% |
| 130° C. for 60 s. | |
| Thermal shrinkage at | transverse <2% |
| 130° C. for 60 s. | |

The surface energy of the untreated BOPP film Radil T25 NT is less than 30 mN/m. The surface energy of the polypropylene surface which is coated with adhesive composition is 52 mN/m after flame pretreatment and from 48 to 50 mN/m after corona treatment.

The opposing surface of the film, which is not coated with the adhesive composition, is provided with a reverse-side lacquer prior to coating by means of the customary technologies.

### Example b

### Flame Pretreatment of the Polypropylene Films

| | |
|---|---|
| Materials: | |
| Film: | Radil T 25 NT (BOPP film, |
| | RADICI), surface energy before |
| | flaming less than 30 mN/m |
| Fuel gas: | propane (technical purity, LINDE) |
| Fuel gas/air mixture: | approximate proportion = 1:28 (v/v) |
| Technical parameters: | |
| Flaming side: | Outer side of the bale |
| Web speed: | 100 m/min |
| Burner/treatment roll distance: | 3 mm |
| Burner temperature: | 38° C. |
| Temperature of the treatment roll: | 15° C. |
| Flame temperature: | 840° C. |
| Volume flow of mixture: | 20 m³/h |
| Effective burner width: | 32 cm |

The film face flamed under this combination of parameters possesses a surface energy of 52 mN/m. A corona pretreatment suitable for comparison purposes normally achieves levels of from 48 to 50 mN/m.

### Example c

### Components of the Adhesive Compositions

c1: Natural rubber TSR 5L obtainable from Weber&Schaer, Hamburg.
c2: Hydrocarbon tackifier resin Hercotac 205 from Hercules B. V., Rijswik, N L
c3: Ground chalk filler, Mikrosohl 40, available from Vereinigte Kreidewerke Dammann K G, Söhide
c4: Plasticizer, paraffinic white oil, Shell Ondina G33 from Deutsche Shell AG, Hamburg
c5: Ageing inhibitor, Lowinox® 22M46 (2,2-methylenebis-[6-(1,1-dimethyl-ethyl)₄-methylphenol)] from GREAT LAKES
c6: Isocyanate crosslinker, 4,4′-diphenylmethane diisocyanate, product Suprasec DNR from ICI Polyurethanes, Löhne

Additionally for formulation of experiment B:
c7: UV crosslinking promoter, Ebecryl 140, dimerized trimethylol-propane tetraacrylate (C₂₄H₃₈O₉) from UCB Chemicals, Radcure Products, Drogenbos, Belgium
c8: Photoinitiator Irgacure 651, 2,2-dimethoxy-1,2-diphenylethan-1-one from Ciba Additive GmbH, Lampertheim, Germany

### Example d

### Adhesive Composition Formulations

The following formulations were used. All formulations are given in phr, i.e. based on 100 parts of rubber.

Formulation A:

Formulation for the chemical crosslinking of the adhesive composition based on a natural-rubber hot-melt pressure-sensitive adhesive by diisocyanate:

| | |
|---|---|
| Natural rubber, granulated | 100 |
| Hercotac 205 | 98 |
| Chalk | 18 |
| White oil | 4 |
| Ageing inhibitor | 2 |
| Diisocyanate | 0.9 |

Formulation B:

Formulation of the uncrosslinked adhesive composition based on a natural-rubber hot-melt pressure-sensitive adhesive:

| | |
|---|---|
| Natural rubber, granulated | 100 |
| Hercotac 205 | 98 |
| Chalk | 18 |
| White oil | 4 |
| Ageing inhibitor | 2 |

Formulation C: Formulation for the crosslinking by UV radiation of an adhesive composition based on a natural-rubber hot-melt pressure-sensitive adhesive:

| | |
|---|---|
| Natural rubber, granulated | 100 |
| Hercotac 205 | 98 |
| Chalk | 18 |
| Ageing inhibitor | 2 |
| Ebecryl 140 | 3.5 |
| Irgacure 651 | 4.5 |

### Example e

### Preparation of the Adhesive Composition

The adhesive compositions based on natural rubber were prepared without solvent in single-stage and multistage procedures.

### Example e1

In a first process step, a prebatch was prepared. The prebatch was prepared in accordance with the formulation designated VB-A in a Banbury compounder of type GK 1.4 N from Werner & Pfleiderer, Stuttgart.

Prebatch Formulation VB-A

| | |
|---|---|
| Natural rubber, granulated | 100 |
| Hercotac 205 | 18 |
| Chalk | 18 |
| White oil | 4 |
| Ageing inhibitor | 2 |

Kneading chamber and rotors were conditioned at a temperature of 25° C., the rotary speed of the blades was 50 min⁻¹. The overall weight of the prebatch was 1.1 kg. All constituents were premixed in dry form and metered together with the white oil.

A mixing time of six minutes was sufficient to homogenize the constituents of the prebatch.

In a second process step, the natural-rubber hot-melt pressure-sensitive adhesive was mixed to completion. In a kneading machine of construction type LUK1.0 K3 from Wemer & Pfleiderer, Stuttgart, all of the other additives were added for this purpose to the prebatch, so giving a natural-rubber hot-melt pressure-sensitive adhesive in accordance with the general formulation A. The prebatch was kneaded for ½ minute, then the entire tackifier resin in accordance with formulation F-A was added. The isocyanate was mixed in after 10 minutes.

Formulation F-A

| | |
|---|---|
| Prebatch VB-A | 142 |
| Hercotac 205 | 80 |
| Diisocyanate | 0.9 |

The formulation F-A corresponds overall to the general formulation A of the natural-rubber hot-melt pressure-sensitive adhesive.

The overall weight of the hot-melt pressure-sensitive adhesive was 500 g. During the entire operation of mixing to completion, the chamber temperature was set at 80° C. The overall kneading time was 10 minutes.

### Example e2

Example e1 was repeated.

To simplify emptying, the second step of the process, mixing to completion, was carried out using a kneading machine of the construction type VI U 20 L from Aachener Mischund Knetmaschinen-Fabrik Peter Kupper, Aachen, with a discharge screw. The prebatch was kneaded for ½ minute, then the entire tackifier resin in accordance with formulation F-A was added. The isocyanate was mixed in after 7 minutes.

The overall weight of the hot-melt pressure-sensitive adhesive was 12 kg. The chamber temperature was set at 80° C. The overall kneading time was 12 minutes, the emptying time 7 minutes.

The uncrosslinked formulation B and the UV-crosslinkable formulation C were prepared in analogy to Example e2 without the addition of isocyanate crosslinker to formulation B, and, respectively, by adding the UV crosslinker and the promoter in the case of formulation C.

### Example e3

The natural-rubber hot-melt pressure-sensitive adhesive was prepared continuously with the aid of a twin-screw extruder UD=36 from FARREL. In this case, the solid components, rubber and chalk, were supplied to the first conveying zone, the resin to the second conveying zone, and the liquid components were metered in.

Gravimetric metering devices, metering pumps and the screw speed were set so as to give a product rate of 10 kg/h with homogeneous mixing. The individual zones were temperature-controlled so as to give a product temperature of 75° C.

### Example e4

The continuous preparation of the adhesive compositions based on natural-rubber hot-melt pressure-sensitive adhesives took place preferably by means of planetary roll extruders.

The planetary roll extruder was operated in each case with one, two or three roll cylinders, each roll cylinder being equipped with 6 planetary spindles and an approach ring having a free cross-section of 44 mm being used between each roll cylinder. The rotary speed of the central spindle was set at 100 revolutions/min. The maximum product rate (Qₘₐₓ) up to which a homogenous compound was obtained was determined for each planetary roll extruder configuration.

In order to keep the natural-rubber granules meterable, they were treated with talc. The granules were produced using a cutting mill from Pallmann.

All of the components of the formulation were used to prepare, in a 50 kg powder mixture, a premix which was metered by way of a volumetric metering device into the filling section of the planetary roll extruder. The temperature-control circuits for the central spindle and the filling section (TC1 and TC2) were water cooled and each roll section was heated at 100° C. The table shows the maximum product rates achieved as a function of the number of roll cylinders.

| Comparative | Number of roll | Qₘₐₓ |
|---|---|---|
| Example | cylinders | [kg/h] |
| 1 | 1 | 45 |
| 2 | 2 | 62 |
| 3 | 3 | 83 |

The components set out above in Example c were supplied continuously to the filling section of the planetary roll extruder, separately, by way of volumetric metering systems. The product exit temperature was measured as 122° C.

### Example f

### Coating of the Adhesive Composition

The continuously prepared and batchwise-prepared natural-rubber hot-melt pressure-sensitive adhesive with diisocyanate on the basis of formulation A, Example d, the non-crosslinked adhesive composition based on a natural-rubber hot-melt pressure-sensitive adhesive formulation B, Example d, and the UV crosslinker- and promoter-containing formulation C, Example d, were used for coating directly after the preparation process, using a flexurally rigid 2-roll applicator unit. For this purpose, a conveying extruder was used in order to convey the adhesive compositions.

An industry-standard 25 μm thick BOPP film, provided with an industry-standard primer coat based on isocyanate and an industry-standard release coat based on carbamate, was used and the adhesive compositions were applied with a film thickness of 18 μm.

The backing film described in a was coated directly, in a film thickness of 18 μm.

Coating took place on a pilot coating plant with a working width of 500 mm.

The coating of the film of adhesive onto the primed face of the film was carried out directly. A coating gap was established between the first coating roll and the second, web-carrying coating roll, in accordance with the application thickness. The first roll was heated at 100° C., the web-carrying roll cooled at 15° C. The adhesive composition emerging from the conveying extruder had a temperature of 120° C. Coating was carried out at 50 m/min. The properties of the adhesive tapes whose adhesive compositions were prepared by means of planetary roll extruders were investigated.

The properties were determined after storage for three days at 23° C.

### Example g

### UV Crosslinking of the Adhesive Composition

The specimens with formulation C were lined with a transparent siliconized polypropylene film and subsequently irradiated using a medium-pressure mercury lamp with an output of 105 W/cm at a speed of 40 m/min. The adhesive composition was irradiated on the one hand through the release film and on the other hand through the reverse of the backing.

### Example h

### Results

The test methods used are briefly characterized below:

The bond strength (peel strength) of the compositions was determined in accordance with AFERA 4001.

The shear strength of the adhesive compositions investigated was determined in accordance with PSTC 7 (Holding Power). All values stated were measured at room temperature and the stated load of 20 N with a bond area of 20×13 mm². The results are reported in minutes of holding time. The adhesion substrate used was steel.

In order to characterize the degree of crosslinking, the gel fraction in toluene was measured. For this purpose, square sections measuring 20 cm² were punched out and welded into a pouch made of a polyethylene spunbonded web (Tyvek from DuPont with a basis weight of approximately 55 g/m²). The specimens were then subjected to extraction with toluene for 3 days, with shaking. The toluene was changed each day. The toluene was subsequently replaced by hexane/heptane and the specimens were dried at 110° C. The gel was determined by differential weighing, taking into account extraction losses of the web and of the backing. The gel fraction is based on the rubber fraction in the formulation of the adhesive composition.

To determine the amount of composition applied, a circular specimen of known surface area is cut from the coated film and weighed. Subsequently, the adhesive composition is removed using petroleum spirit and the film, now free of adhesive composition, is reweighed. The amount of composition applied, in g/m², is calculated from the difference.

In order to characterize the tack with respect to cardboard, the adhesive tape is applied to the cardboard using a standard commercial manual roller and pressed on using a steel roller weighing 2 kg (overrolled twice). After a waiting time of 3 minutes, the adhesive tape is pulled off parallel at a speed of about 30 m/min and at an angle of approximately 1300 to the cardboard surface. The tack with respect to cardboard is assessed qualitatively on the basis of the amount of paper fibres torn out, in comparison with a standard commercial adhesive packaging tape such as tesapack 4124 from Beiersdorf, whose tack is characterized as very good.

| | Formulation A | Formulation B | Formulation C | |
|---|---|---|---|---|
| | Crosslinking by | | | |
| | diisocyanate | not | UV crosslinking through the | |
| Property | crosslinker | crosslinked | release film | reverse |
| Adhesive composition | 18 | 18 | 18 | 18 |
| applied [g/m²] | | | | |
| Primer coat (standard) | no | no | yes | yes |
| Physical pretreatment | flaming | flaming | corona | corona |
| of the film | | | before | before |
| | | | primer | primer |
| Anchoring of composition | good | moderate | good | good |
| Gel fraction | — | 0% | 72% | 72% |
| Shear strength 20 N steel | >10,000 min | 488 | 7200 min | >10,000 min |
| Bond strength on steel | 3.1 N/cm | 3.0 N/cm | 1.8 N/cm | 1.8 N/cm |
| Tack with respect to | good | good | good | good |
| cardboard | | | | |

1-12. (canceled)

13. A method for sealing cartons, which comprises sealing said cartons with an adhesive tape comprising a backing comprising an oriented thermoplastic film to which a coating comprising a solventlessly prepared pressure-sensitive adhesive composition based on non-thermoplastic elastomers and comprising a thermally labile crosslinking system is applied, said composition being prepared continuously without solvent and without mastication in a continuously operating device having a filling section and a compounding section, by a process comprising the steps of
a) feeding the solid components of the self-adhesive composition into the filling section of the device, optionally feeding fillers, dyes, crosslinkers or combinations thereof,
b) transferring the solid components of the self-adhesive composition from the filling section to the compounding section,
c) adding the liquid components of the self-adhesive composition to the compounding section,
d) preparing a homogeneous self-adhesive composition in the compounding section, and
e) discharging the self-adhesive composition
said coating being crosslinked after application to said film.

14. Method according to claim 13, wherein the thermoplastic film comprises biaxially oriented HDPE, PVC or PET, monoaxially oriented polypropylene or biaxially oriented polypropylene.

15. Method according to claim 13, wherein the adhesive composition comprises a mixture comprising:
a) 100 parts by weight of natural rubber
b) 70-120 parts by weight of tackifying resins based on hydrocarbons
c) 5-30 parts by weight of fillers
d) 2-20 parts by weight of plasticizers
e) 0.1-15 parts by weight of a crosslinker system
f) 0.5-5 parts by weight of ageing inhibitors.

16. Method according to claim 13, wherein the crosslinker system is based on isocyanates, and is used in an amount of 0.1-5.0 parts by weight.

17. Method according to claim 13, wherein the crosslinker system comprises a mixture of at least one photoinitiator in an amount of 0.1-5 parts by weight, and at least one polyfunctional (meth)acrylic ester in an amount of 0.5-10 parts by weight.

18. Method according to claim 13, wherein the pressure-sensitive adhesive composition is crosslinked by means of accelerated electrons or UV radiation.

19. Method according to claim 13, wherein a coat of a primer is applied between the thermoplastic film and the adhesive layer.

20. Method according to claim 13, wherein the thermoplastic film comprises a release coating.

21. Method according to claim 13, wherein the adhesion of the adhesive composition to the thermoplastic film is improved by corona treatment or flame pretreatment.
